(19) United States
(12) Patent Application Publication
(10) Pub. No.: US 2024/0265467 A1
(43) Pub. Date: Aug. 8, 2024

(54) SYSTEMS AND METHODS for GENERATING SUBSCRIPTION-BASED INSURANCE POLICIES WITH PREDESIGNATED COVERAGE AMOUNTS

(71) Applicant: State Farm Mutual Automobile Insurance Company, Bloomington, IL (US)

(72) Inventors: Ryan Michael Gross, Normal, IL (US); Jody Ann Thoele, Bloomington, IL (US); Joseph Robert Brannan, Bloomington, IL (US); Eric R. Moore, Heyworth, IL (US)

(21) Appl. No.: 18/640,685

(22) Filed: Apr. 19, 2024

Related U.S. Application Data
(63) Continuation of application No. 18/198,724, filed on May 17, 2023.
Application No. 18/198,724 is a continuation of application No. 17/124,153, filed on Dec. 16, 2020, now abandoned.
(60) Provisional application No. 63/043,568, filed on Jun. 24, 2020.
(60) Provisional application No. 62/949,643, filed on Dec. 18, 2019.

(51) Int. Cl. G06Q 40/08; G06Q 30/0201; G06Q 30/0204; H04W 4/38

(52) U.S. Cl. CPC G06Q 40/08; G06Q 30/0205; G06Q 30/0206; H04W 4/38

(57) ABSTRACT

A computer system for providing group insurance plans may be provided. The computer system may include a processor in communication with a memory device, and the processor may be configured to: (i) receive registration data associated with a group of users including a list of users included in the group and user data from each user; (ii) generate a plurality of predesignated insurance personal mobility policy plans or usage-based insurance plans for the group including a predesignated coverage amount and a corresponding premium amount over a predesignated time period; (iii) prompt a user of the group to select a predesignated policy; (iv) store the selected predesignated policy along with the group registration data; (v) receive mobility data after each trip of each user of the group; (vi) adjust the selected coverage amount based upon the mobility data; and/or (vii) determine a current coverage amount based upon the adjusted coverage amount.

### CROSS-REFERENCE TO RELATED APPLICATIONS

This application is a continuation of and claims priority to U.S. patent application Ser. No. 18/198,724, filed May 17, 2023, which is a continuation of and claims priority to U.S. patent application Ser. No. 17/124,153, filed Dec. 16, 2020, which claims priority to, and claims the benefits of, U.S. Provisional Patent Application Ser. No. 63/043,568, filed Jun. 24, 2020, entitled “Systems and Methods for Generating Subscription-Based Insurance Policies with Predesignated Coverage Amounts,” and U.S. Provisional Patent Application Ser. No. 62/949,643, filed Dec. 18, 2019, entitled “Systems and Methods for Generating Subscription-Based Insurance Policies with Predesignated Coverage Amounts,” the contents of which are hereby incorporated by reference, in their entirety and for all purposes, herein.

### FIELD OF THE DISCLOSURE

The present disclosure relates to subscription-based insurance policies, and more specifically, to systems and methods for generating subscription-based insurance policies (e.g., for a user or a group of users) with predesignated coverage amounts (e.g., a predesignated number of miles, a predesignated amount of travel time, and/or a predesignated number of trips).

### BACKGROUND

At least some known insurance policies (e.g., vehicle insurance) provide insurance coverage for vehicles and owners/users of the vehicles for a premium. The insurance policies and corresponding premiums may be based upon, on average, how often the owner(s) of the vehicle drive the vehicle, the annual mileage of the vehicle, characteristics of the vehicle (e.g., an age of the vehicle, safety features included in the vehicle, etc.), and vehicle owner information (e.g., historical claim data, driving record data, and owner location data).

Generating known insurance policies and corresponding premiums may have drawbacks for both vehicle users and insurance providers. For example, if a newly-licensed driver (e.g., a 16-year-old) wishes to be covered by an insurance policy, the premium for the driver may be very high, even if the driver only plans to drive occasionally. Accordingly, the driver may be paying very high insurance premiums to be insured, even if the driver typically drives with friends or family members.

Further, it may be difficult for insurance providers to accurately determine how often/how many miles a driver drives their vehicle, and the insurance companies may be unable to determine whether a driver typically has dangerous driving behavior and/or if the driving routes typically taken by the driver are high-risk. Therefore, it may be difficult for the insurance companies to precisely price the insurance policies for the driver. Conventional methods and techniques of generating known insurance policies and corresponding premiums may have other drawbacks as well.

### BRIEF SUMMARY

The present embodiments may relate to systems and methods for providing group/subscription policies that include a predesignated coverage amount and a corresponding premium amount. In the exemplary embodiment, the methods may be carried out by an insurance subscription server. The subscription-based insurance policies discussed herein may have predesignated coverage amounts that may be shared by a group of users (e.g., a family) or used by a single user. The present embodiments may also relate to providing PMP (personal mobility policies) and/or micro-mobility usage-based insurance (UBI) to various groups, such as families, households, peer groups, social groups, etc.

In one aspect, a computer system for providing group insurance plans may be provided. The computer system may include at least one processor and/or associated transceiver in communication with at least one memory device, and the at least one processor may be configured to: (i) receive registration data associated with a group of one or more users, wherein the group registration data may include (a) a list of the one or more users included in the group, and (b) user data associated with each user included in the group. The user data may include at least one of demographics data, historical vehicle telematics data, and historical insurance claim data. The at least one processor may be configured to: (ii) generate, based upon the registration data, a plurality of predesignated insurance policies for the group, wherein each of the predesignated policies includes a predesignated coverage amount for the group and a corresponding premium amount over a predesignated time period; (iii) prompt at least one user of the group to select a predesignated policy; (iv) store, in the at least one memory device, the selected predesignated policy along with the group registration data; (v) receive current vehicle telematics data after each trip of each user of the group; (vi) adjust the selected coverage amount based upon the current vehicle telematics data; and/or (vii) determine a current coverage amount based upon the adjusted coverage amount. The computer system may include additional, less, or alternate functionality, including that discussed elsewhere herein.

In another aspect, a computer-implemented method for providing group insurance plans may be provided. The method may be implemented using a computer system including at least one processor and/or associated transceiver in communication with at least one memory device. The method may include, via the at least one processor and/or associated transceiver: (i) receiving registration data associated with a group of one or more users. The group registration data may include (a) a list of the one or more users included in the group, and (b) user data associated with each user included in the group. The user data may include at least one of demographics data, historical vehicle telematics data, and historical insurance claim data. The method may include, via the at least one processor and/or associated transceiver: (ii) generating, based upon the registration data, a plurality of predesignated insurance policies for the group, wherein each of the predesignated policies may include a predesignated coverage amount for the group, and a corresponding premium amount over a predesignated time period; (iii) prompting at least one user of the group to select a predesignated policy; (iv) storing, in the at least one memory device, the selected predesignated policy along with the group registration data; (v) receiving current vehicle telematics data after each trip of each user of the group; (vi) adjusting the selected coverage amount based upon the current vehicle telematics data; and/or (vii) determining a current coverage amount based upon the adjusted coverage amount. The method may include additional, less, or alternate actions, including those discussed elsewhere herein.

In yet another aspect, at least one non-transitory computer-readable media having computer-executable instructions thereon may be provided. When executed by at least one processor and/or associated transceiver of a computer system in communication with at least one memory device, the instructions may cause the at least one processor and/or associated transceiver to: (i) receive registration data associated with a group of one or more users. The group registration data may include (a) a list of the one or more users included in the group, and (b) user data associated with each user included in the group. The user data may include at least one of demographics data, historical vehicle telematics data, and historical insurance claim data. The instructions may cause the at least one processor and/or associated transceiver to: (ii) generate, based upon the registration data, a plurality of predesignated insurance policies for the group, wherein each of the predesignated policies includes a predesignated coverage amount for the group, and a corresponding premium amount over a predesignated time period; (iii) prompt at least one user of the group to select a predesignated policy; (iv) store, in the at least one memory device, the selected predesignated policy along with the group registration data; (v) receive current vehicle telematics data after each trip of each user of the group; (vi) adjust the selected coverage amount based upon the current vehicle telematics data; and/or (vii) determine a current coverage amount based upon the adjusted coverage amount. The instructions may direct additional, less, or alternate functionality, including that discussed elsewhere herein.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary computer system in accordance with an exemplary embodiment of the present disclosure.

FIG. 2 depicts a flow chart of an exemplary process that may be carried out by the computer system illustrated in FIG. 1.

FIG. 3 depicts an exemplary client computing device that may be used with the exemplary computer system illustrated in FIG. 1.

FIG. 4 depicts an exemplary server system that may be used with the exemplary computer system illustrated in FIG. 1.

FIG. 5 illustrates a diagram of components of one or more exemplary computing devices that may be used in the exemplary computer system shown in FIG. 1.

FIG. 6 illustrates a flow chart of an exemplary computer-implemented process that may be carried out by the exemplary computer system shown in FIG. 1.

FIG. 7 illustrates a flow chart of an exemplary computer-implemented process that may be carried out by the exemplary computer system shown in FIG. 1.

FIG. 8 illustrates a flow chart of an exemplary computer-implemented process of allocating PMP and micro-mobility UBI blocks to group members that may be carried out by the exemplary computer system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for providing subscription-based insurance policies to users (e.g., owners of vehicles, drivers of vehicles, etc.). The subscription-based insurance policies may include vehicle insurance policies, personal mobility policies, and usage-based insurance (UBI). In one exemplary embodiment, the process may be performed by an insurance subscription (“IS”) server (also referred to herein as an IS computing device or an IS computer system). In some embodiments, the IS server may be associated with an insurance provider.

The systems and methods described herein may generate predesignated policies for an individual user and/or a group of users (e.g., users who wish to share the predesignated policy). The IS server may receive user data (e.g., demographic, historical telematics data, and/or historical claim data) and/or registration data (e.g., a list of users included in a group) from users through a user device. Based upon the received user data and/or registration data, the IS server may generate predesignated policies (e.g., predesignated subscription policies) including a predesignated coverage amount, and a corresponding premium over a predesignated time period.

The predesignated coverage amount associated with the predesignated policies may include at least one of (i) a predesignated amount of miles, (ii) a predesignated amount of travel time, and/or (iii) a predesignated amount of trips. In the case of a group predesignated policy, the predesignated coverage amount may be shared amongst each user of the group. After the users have determined which generated predesignated policy the users would like to be covered under, the IS server may store the predesignated policy in a database or other memory device in communication with the IS server.

After each trip that the users complete, the IS server may determine (e.g., through telematics data) at least one of (i) an amount of miles driven on the trip, (ii) an amount of travel time of the trip, and/or (iii) that a trip was taken. The IS server may subtract the determined amount from the predesignated coverage amount to determine a current coverage amount (e.g., a remaining coverage amount). Accordingly, the IS server may provide and manage a subscription-based/predesignated insurance policy for users, wherein the insurance policy is a subscription to the coverage amount over a predetermined time period.

### Receiving Historical User Data

In an exemplary embodiment, the IS server may receive historical user data. The historical user data may include user information, historical telematics data, and/or historical claim data. The user information may include a name, a sex, an address, a location, and/or any other information of the user. The historical telematics data may include any historical data relating to a use of a vehicle associated with the user (e.g., miles driven by the user, amount of time the user drives, a number of hard braking events, a number of fast cornering events, a number of fast acceleration events, acceleration information, braking information, cornering information, speed information, etc.). The telematics data may be generated by sensors included in a user device (e.g., GPS sensor, accelerometer, and/or gyroscope) and/or telematics sensors included in and/or communicatively coupled to a vehicle of the user. Historical claim data may include any insurance claims filed by and/or against the user.

From the historical user data, the IS server may determine driving patterns and/or driving behaviors of the users. For example, the IS server may determine that a user has generally good driving behaviors if the historical user data of the user shows, for example, that the user has very few hard stops, that the user typically steadily and appropriately accelerates, and that has very few instances of fast cornering. Further, the IS server may determine an average amount of miles that the user drives, an average amount of trips that the user takes, and/or an average amount of time that the user operates a vehicle of the user. These averages may be determined by the IS server over any period of time (e.g., monthly, bi-monthly, every six months, yearly, etc.).

In some embodiments, users may wish to enroll in a group insurance plan through the IS server. The IS server may receive a list of users included in the group (e.g., from a lead or primary user), and user data associated with each user of the group. The IS server may collect all of the user data and determine general driving patterns and/or driving behaviors of the group as a whole. For example, one user of the group may have a nearly perfect driving record (e.g., driving patterns) and driving behavior (e.g., very few hard braking events, no tickets, and no accidents), and another user of the group may have generally bad driving record and/or driving behaviors (e.g., many hard braking events, four speeding tickets, and one accident). Accordingly, the IS server may average the user data of the two users to determine that the group as a whole has an average driving record and behaviors.

### Generating Predesignated Policies

The IS server may generate predesignated policies (e.g., each including different predesignated coverage amounts) for the users to select from based upon the received user data and determined driving patterns/behaviors of the users. Each of the generated predesignated policies may include a predesignated coverage amount, and a corresponding premium for a predesignated time period. The predesignated coverage amount may include a predesignated (or set) amount of miles, a predesignated amount of travel time, and/or a predesignated amount of trips.

The IS server may generate a predetermined number of predesignated policies from which the users may choose. For example, the IS server may generate predesignated policies for high coverage (e.g., including a high predesignated coverage amount), medium coverage (e.g., including a medium predesignated coverage amount), and basic coverage (e.g., including a basic predesignated coverage amount). Accordingly, if the IS server determines, from the user data, that a user drives an average of 1,000 miles a month, the IS server may generate a high coverage option (e.g., including 1,500 miles a month for the predesignated coverage amount), a medium coverage option (e.g., including 1,200 miles a month for the predesignated coverage amount), and a basic coverage option (e.g., including 1,000 miles a month for the predesignated coverage amount).

Further, if the IS server determines, from the user data, that a group of users takes an average of 150 trips per month, the IS server may generate a high coverage option (e.g., including 200 trips per month for the predesignated coverage amount), a medium coverage option (e.g., including 175 trips per month for the predesignated coverage amount), and a basic coverage option (e.g., including 150 trips per month for the predesignated coverage amount).

The IS server may generate predesignated policies that offer a discount per coverage amount for increased coverage amounts. For example, the IS server may generate predesignated policies that include 150 trips per month for a premium of $2.00 per trip (e.g., $300 a month) and then any trips after the 150 trips being $2.50 per trip, 175 trips per month for a premium of $1.80 per trip (e.g., $315 a month) and then any trips after the 175 trips being $2.25 per trip, and 200 trips per month for a premium of $1.60 per month (e.g., $320 a month) and then any trips after the 200 trips being $2.00 per trip.

In other embodiments, the IS server may generate a suggested predesignated policy for the users based upon the user data. For example, the IS server may determine that a group of users spend an average of 150 hours driving per month, that the maximum amount of time that the users have driven their vehicles in a month is 200 hours, and that the minimum amount of time that the users have driven their vehicles in a month is 140 hours. Accordingly, the IS server may generate a suggested predesignated policy for the users including 165 hours for the predesignated coverage amount per month.

### User Selection of Predesignated Policy

The IS server may cause the generated predesignated policies to be displayed to the users (e.g., through a user interface) and prompt the users to select a predesignated policy. In some embodiments, the user may be able to select the predesignated policy with minimal input (e.g., using one-click).

In other embodiments, the IS server may allow the users to provide additional input. For example, the user may request different policies to better meet the needs of the user, if the predesignated policy is for a group of users, add or delete users from the group, etc. In the case of a group of users, a single user (e.g., an admin user for the group) may select the predesignated policy for the group.

The user may choose the predesignated policy based upon the needs of the users. For example, if the users want to pay the least amount possible for an insurance premium, the users may select the basic level of coverage. If the users prefer to have a high coverage amount and are willing to pay a higher insurance premium, the users may select the high level of coverage.

When the users have selected the predesignated policy, the IS server may store the predesignated policy level and the associated users (or user identifiers associated with the users) in a database associated with the IS server. In the exemplary embodiment, the IS server may be in communication with and/or part of an insurance provider device (e.g., associated with an insurance provider of the users) such that the IS server may finalize the insurance policy of the users after the users accept the terms and conditions of the insurance policy (e.g., such that the selected insurance policies of the users is immediately effective). In other embodiments, the IS server may transmit the selected predesignated policy to the insurance provider device such that the insurance provider may finalize the insurance policy of the users, and receive any additional information from the users (e.g., payment information, how to split the payment of the premium amongst a group, etc.).

### Receiving Current Vehicle Telematics Data

Once the users have selected and enrolled in the predesignated policy, the IS server may begin to receive current telematics data (also referred to herein as vehicle telematics data) for the users. That is, the IS server may begin to receive current telematics data from GPS sensors, accelerometers, and/or gyroscopes included in user devices of the users using the corresponding vehicles and/or telematics sensors included in or on the vehicles of the users. The IS server may receive the current telematics data after each trip completed by the users or after any predetermined length of time (e.g., at the end of each day, twice a day, at the end of each week, etc.).

From the current telematics data, when the current telematics data is received by the IS server during or after each trip, the IS server may determine, based upon the current telematics data, an amount of miles driven during the trip, an amount of time of the trip, and/or that a trip was taken. The IS server may store the determined information in a database associated with the IS server. In some embodiments, the IS server may store the determined information for each individual user (e.g., users associated with a single user insurance policy), or for each group of users (e.g., users associated with a group insurance policy). Further, the IS server may delete the stored determined information after each predesignated time period associated with the predesignated policies has passed.

If, for example, there are multiple users driving together in a vehicle, the IS server may determine a driver of the vehicle. The IS server may determine the driver of the vehicle through user input (e.g., prompting each of the users to input whether the user is a passenger or the driver), through matching known driving characteristics of the users with the driving characteristics of the driver (e.g., by matching driving profiles of the driver to driving profiles of each user to determine which driving profile is most similar), determining which user device is located nearest to the driver seat, and/or through any other driver determination method. It may be necessary for the IS server to determine the driver of a vehicle, especially in instances where multiple drivers with subscription-based insurance policies are driving together in a vehicle. Accordingly, the IS server may only attribute the received current telematics data to the determined driver of the vehicle instead of to each user of the vehicle (e.g., the passengers).

### Adjusting Coverage Amount and Determining Risk

The IS server may utilize the determined information (e.g., the amount of miles driven during the trip, the amount of time of the trip, and/or that the trip was taken) to adjust the coverage amount associated with the predesignated policy over the predesignated time period. The adjusting may include the IS server accounting for and staying up-to-date on a current coverage amount (e.g., a remaining coverage amount after each trip is taken) of the insurance policy of the users. The IS server may subtract the determined information from a previous coverage amount (e.g., before the last trip was taken) to determine a subsequent current coverage amount (e.g., a coverage amount remaining after the last trip was taken).

For example, a predesignated policy for a group of users may have a predesignated coverage amount of 1,500 miles per month. When a first user takes a first trip of the month, the IS server may receive the current telematics data from the trip. From the current telematics data, the IS server may determine that the first user drove 15 miles during the trip. Accordingly, the IS server may subtract the 15 miles from the coverage amount of 1,500 miles to arrive at a current coverage amount of 1,485.

When a second user takes a second trip, the IS server may determine, from the current telematics data associated with the second trip, that the second user drove 100 miles during the trip. Accordingly, the IS server may subtract the 100 miles from the 1,485 miles (e.g., the previous current coverage amount) to arrive at a current coverage amount of 1,385 miles. The IS server may continue to adjust the current coverage amount after each trip is taken over the month (e.g., the predesignated time period).

Further, for example, a predesignated policy for an individual user may have a predesignated coverage amount of 30 trips for a pre-paid premium of $60 and every trip after the 30 trips costing $2.15 a trip for a month. The IS server may receive telematics data from each trip of the user and subtract each trip from the predesignated coverage amount of 30 trips. If and/or when the user reaches the 30 trips mark, the IS server may count the number of trips after the 30 trip mark and charge the user for those additional trips at the end of the month (e.g., at the end of the predesignated time period).

In some embodiments, the IS server may, after receiving current telematics data from a trip, determine a risk factor associated with the trip. The IS server may assign a high risk factor to trips that are known to be more dangerous and/or accident-prone (e.g., trips taken in the middle of the night, trips taken in inclement weather including heavy rainfall and snowy or icy conditions, trips taken on scooters in busy city streets, etc.). Further, the IS server may assign a low risk factor to trips that are known to be very unlikely to be dangerous and/or accident-prone (e.g., trips taken on weekend mornings, trips taken during weekdays not during rush hour, etc.). The IS server may generate, based upon the risk factor associated with each trip, a risk multiplier for the trip.

A high risk multiplier may be associated with trips that have high risk factors, and a low risk multiplier may be associated with trips that have low risk factors. For example, if the IS server determines that a trip has a very high risk factor, the IS server may determine that a risk multiplier for the trip is 2. Further, if the IS server determines that a trip have a low risk factor, the IS server may determine that a risk multiplier for the trip is 0.9.

The IS server may further adjust the current coverage amount based upon the determined risk multiplier after each trip. In some embodiments, the IS server may multiply the determined information for the trip by the risk multiplier before subtracting the determined information for the trip from the previous current coverage amount. For example, a user may have a predesignated policy that includes a coverage amount of 60 hours of driving per month. The IS server may determine that the first trip of the user for the month is a trip lasting one hour. Further, the IS server may determine that the first trip was at rush hour in a very congested location and may generate a moderate risk factor for the first trip. Accordingly, the IS server may determine that a risk multiplier for the trip is 1.25. To generate a current coverage amount, the IS server may multiple the one hour of driving by the 1.25 risk multiplier, and the IS server may subtract the multiplied amount (e.g., 1.25 hours) to come up with a current coverage amount of 58.75 hours.

In the exemplary embodiment, higher risk trips may lower the current coverage amount of the users more than lower risk trips, and users that regularly take high risk trips may run out of the coverage amount (e.g., the subscription amount) more quickly than users that regularly take low risk trips. Accordingly, the IS server may encourage users to take more low risk trips and drive more safely.

### Notifying Users Regarding Current Coverage Amounts and Adding Additional Coverage

As the IS server determines current coverage amounts, the IS server may display (e.g., via an application hosted by the IS server on a user device) the current coverage amounts and/or notify users about the current coverage amounts. In some embodiments, the IS server may notify users (e.g., through a push notification and/or an SMS message) each time the current coverage amount is adjusted. For example, if a group of users share a predesignated policy, the IS server may notify an administrative user each time the current coverage amount for the group is adjusted. In other embodiments, the IS server may notify users of the current coverage amount at predetermined times (e.g., at the end of each week, at the beginning of each week, at the end of each day, bi-weekly, etc.).

In further embodiments, the IS server may notify users only if the current coverage amount falls below a threshold. For example, if a user has a predesignated policy including 50 hours of drive time per month, and the current coverage amount of the user falls below 10 hours, the IS server may notify the user of the low current coverage amount.

The IS server may determine and suggest an additional coverage amount to the user in the low coverage amount notification. For example, if the user has been driving 20 hours per week, and the user currently has 10 hours left of the predesignated coverage amount and a week and a half left of the month, the IS server may determine and suggest an additional 30 hours to get the user through the end of the month. Additionally, the notification may include an option for the user to accept and add the suggested additional coverage amount with minimal input from the user (e.g., with one-click). Further, the notification may include an option for the user to change the suggested additional coverage amount (e.g., to add more or less additional coverage) or deny the additional coverage amount.

If the user adds an additional coverage amount, the IS server may determine a prorated premium for the additional coverage based upon the predesignated policy of the users, and the IS server may charge and/or bill the users accordingly. The IS server may adjust the current coverage amount to include the additional coverage amount such that the previous current coverage amount plus the additional coverage amount is a subsequent current coverage amount. Further, the IS server may store that the users added additional coverage amounts (e.g., in a database of the IS server).

### Adjusting Subsequent Coverage

The IS server may adjust subsequent predesignated policies for individual users and/or groups of users based upon user data and telematics data received throughout the previous predesignated time period.

For example, the IS server may retrieve, after the previous predesignated time period has passed, claim data and/or driving record of the individual user and/or the group of users for the predesignated time period. In some embodiments, the IS server may retrieve the claim data and driving record data from one or more third party databases (e.g., city/county/state police databases or other databases that store driving record data). If any of the individual user and/or the group of users had to file a claim (e.g., was in an accident), got a speeding ticket, and/or had any other negative changes in the driving record, the IS server may adjust a premium of the subsequent predesignated policy.

That is, since the driving record of one or more of the users changed, the IS server may increase the premium of the subsequent predesignated policy to account for the additional risk of insuring the one or more users. Further, if any of the individual user and/or group of users did not have to file any claims and were not cited for bad driving behaviors, the IS server may offer a reward to the individual users and/or group of users. For example, the IS server may offer a discount of the premium for the subsequent predesignated policy and/or the IS server may offer a specific amount toward the premium for the subsequent predesignated policy.

Additionally, for example, the IS server may analyze the final current coverage amount of the previous predesignated time period (e.g., the coverage amount remaining at the end of the predesignated time period). Further, the IS server may retrieve whether the user or group of users added additional coverage to the predesignated coverage amount. Based upon the analyzed final current coverage amount, the IS server may recommend a different predesignated policy for the user or group of users. For example, if the user or group of users had a substantial remaining coverage amount (e.g., the final current coverage amount for the time period is very large), the IS server may suggest a predesignated policy that has a lower coverage amount and a lower premium. Further, if the user or group of users had to add additional coverage amounts more than once, the IS server may suggest a predesignated policy that has a higher coverage amount and/or a higher premium.

Additionally, if the user of group of users have a balance in the final current coverage amount, the IS server may add the balance to a subsequent predesignated coverage amount. For example, if a user has 10 trips left over at the end of the predesignated time period, the IS server may add the 10 trips to a subsequent predesignated coverage amount for a subsequent predesignated time period. Accordingly, the IS server may allow unused coverage amounts of the predesignated policy to “rollover” into subsequent predesignated time periods.

### Exemplary PMP & Micro-Mobility UBI Embodiments

In one aspect, the present embodiments may relate to personal mobility policies (PMP). In some embodiments, a PMP may provide insurance protection for customers who do not own a vehicle and/or do not drive. For example, the user may travel from place to place by using various alternative forms of transportation, including walking, biking, using public transportation, and/or using ride-sharing services. In these cases, personal mobility insurance may offer coverage if the user is injured as (i) a ride-share service passenger due to the driver's negligence or fault, (ii) a pedestrian getting into or out of a ride-share vehicle, and/or (iii) a bike or electric scooter rider due to being injured by an uninsured motorist.

“Personal mobility (PM) insurance” or “personal mobility policy (PMP),” as used herein, may refer generally to insurance policies based upon a user's usage of various forms of transportation. As increasingly more personal mobility options (e.g., modes of transportation) become available, users have more options to choose from when it comes to travel. Personal mobility insurance may provide coverage when a user is a pedestrian, a passenger of a ride-sharing service, and/or a driver of a rental vehicle, a semi-autonomous vehicle, and/or an autonomous vehicle. In other cases, personal mobility insurance may provide a user with coverage when the user rides a bike or an electric scooter.

In some embodiments, personal mobility insurance may be associated with an alternative policy, such as a personal automobile insurance and/or a vehicle rental insurance. For example, a user's coverage may switch between the user's personal automobile insurance and the user's personal mobility insurance depending on whether the user elects to use their personal vehicle or a different mode of transportation, such as a ride-sharing service, to travel from one place to another. The cost of the personal mobility policy may depend on various factors, including, but not limited to, mode of transportation and risk associated with each mode of transportation.

Additionally, the present embodiments may relate to micro-mobility or micro mobility trends. For instance, the PMP or other insurance policies may cover micro-mobility forms of transformation and/or provide micro-mobility coverage on demand. The present embodiments may provide micro-mobility coverage or micro-mobility insurance for short distance travel—such as the first mile of a trip (such as to reach or travel to a public transportation or a ride share pick-up point), or the last mile of the trip (such as to reach or travel to a final destination, such as via e-scooter or bike).

Additionally or alternatively, the PMP, or other insurance policies discussed herein, may relate to various forms of transportation, such as driving a rental car, borrowing a friend's car, being a passenger in a ride share, public transportation, bicycles, scooters, e-scooters, walking, etc. The PMP or other insurance policies may provide protection for covered injuries when a policyholder is using one of the various forms of transportation.

In another aspect, the present embodiments may relate to micro-mobility or micro-mobility trends. For instance, the PMP or other insurance policies may cover micro-mobility forms of transformation (e.g., e-scooters, bikes, etc.) and/or provide micro-mobility coverage on demand. The present embodiments may provide micro-mobility coverage or micro-mobility insurance for short distance travel, such as the first mile of a trip (e.g., to reach or travel to a public transportation and/or a ride share pick-up point), or the last mile of the trip (e.g., to reach or travel to a final destination, such as via e-scooter or bike).

In some embodiments, the micro-mobility coverage or insurance may be in the form of UBI (usage-based insurance). UBI micro-mobility coverage may be sold, for example, by time, mileages, or other units (e.g., rides). In one embodiment, the micro-mobility coverage may cover modes of transportation and/or vehicles with speeds less than 20 mph, that only carry 1 or 2 people, and are associated with trips of short distances (e.g., one or two miles).

“On-demand insurance,” as used herein, may refer generally to providing PMP (personal mobility policy) and/or micro-mobility UBI (usage-based insurance) quotes to a user in real time when coverage is requested by a user. On-demand insurance may provide coverage on a pay-as-you-go basis for each trip taken by the user (e.g., insurance provided on a trip-by-trip basis), as opposed to paying for coverage for a standard period of time (e.g., six months). For example, coverage may be requested or purchased for certain trips a user plans to take. PMP and/or micro-mobility insurance may be offered in various units, such as miles, time units, or rides. Micro-mobility insurance may cover short trips, such as the first mile and/or the last mile to a destination. For instance, the first mile and/or last mile to a destination may include users traveling by alternate forms of transportation, such as public transportation, ride shares, bicycles, or e-scooters.

In one aspect, the present embodiments may provide for group PMP insurance or coverage. For example, a “family plan” may allow a family or household to pay for “by the mile” insurance coverage. This may be similar to typical “family cell phone” plans. The family plan may cover members of a family, a household, apartment, house, peer group, social group, social media group, affinity group, team, or other groups.

A group of people (2-5) may buy a block of time, miles, or rides of insurance coverage. This block, as an example may be 150 miles of insurance coverage that may be free for anyone on the family plan to use. Group insurance plans may help sell higher value plans while spreading the risk to multiple users (e.g., riders). There may also be some aspects of incentive for groups that have no claims for a predetermined time period. For example, the group may be given a larger discount or deductible for those who have not filed a claim after a year.

The insurance provider may sell blocks or rides (e.g., 100 rides to a family of five), and any of a family or household may use rides from among the block of 100. When the rides are all used, the family may purchase another block, or alternatively, may purchase coverage per ride. Additionally, rollover miles may be provided for any unused miles or rides during a policy time period.

In one embodiment, each user or customer within a family may be allotted a given amount of miles or rides, such as having a bucket of a predetermine number of miles per month. If they become “low” on miles or rides, other family members may share their miles or rides with the family member that is low.

The present embodiments may also provide a gamification opportunity for those who have low or no claim history.

In another aspect, PMP subscription insurance or coverage may be provided. This may be a type of UBI. For example, instead of paying by the time, mile, or ride, a user may select the subscription level that suits them and/or their family or group best. One may buy a “set number of rides” per month as a subscription.

For instance, the PMP subscription insurance may start off with 10 rides for $9, and each ride above that may cost $1.50. The second subscription level may be 20 rides for $17, and $1.25 for additional rides. The following plan may be 50 rides for $30, and $1 per ride after, etc.

In other words, customers may buy rides or “credits.” Customers may purchase a block of credits which may be used for individual rides. Credit usage may be associated with risk, e.g., a TNC (transportation company) ride may be equal to 1 credit, and a scooter ride may be equal to 1.5 credits since scooter accidents are more likely/severe.

Rollover credits may also be an option. For example, redeemable monthly credits may carryover on a monthly basis.

At least one technical problem addressed by this system may include: (i) inability of insurance providers to accurately determine usage metrics of vehicles of users (e.g., users/consumers covered by the insurance company), (ii) lack of subscription-based insurance policies for both individual users and groups of users, (iii) inability of users to form group with which the users wish to share insurance policies, (iv) inability of insurance providers and users to determine current coverage amounts after each trip taken by the users, (v) inability of insurance providers to charge more for high risk trips on a trip-to-trip basis, (vi) lack of insurance policies that encourage better driving behaviors for users through group insurance policies, (vii) inability of insurance providers to change premiums from month to month based upon driving behaviors/records of users of the previous month(s), and/or (viii) lack of insurance policies for users that do not own a vehicle or do not drive. Further, there may be additional problems addressed by the system.

The methods and systems described herein may be implemented using computer programming or engineering techniques including computer software, firmware, hardware, or any combination thereof, where the technical effect may be achieved by performing at least one of the following steps: (i) receiving registration data associated with a group of one or more users, wherein the group registration data includes (a) a list of the one or more users included in the group, and (b) user data associated with each user included in the group, wherein the user data includes at least one of demographics data, historical vehicle telematics data, and historical insurance claim data, (ii) generating, based upon the registration data, a plurality of predesignated insurance policies for the group, wherein each of the predesignated policies includes a predesignated coverage amount for the group and a corresponding premium amount over a predesignated time period, (iii) prompting at least one user of the group to select a predesignated policy, (iv) storing, in the at least one memory device, the selected predesignated policy along with the group registration data, (v) receiving current vehicle telematics data after each trip of each user of the group, (vi) adjusting the selected coverage amount based upon the current vehicle telematics data, and/or (vii) determining a current coverage amount based upon the adjusted coverage amount. The technical effect may be achieved through additional, less, or alternate actions, including those discussed elsewhere herein.

At least one technical solution addressed by this system may include: (i) providing methods for insurance providers to accurately determine usage metrics of vehicles of users (e.g., users/consumers covered by the insurance company), (ii) providing subscription-based insurance policies for both individual users and groups of users, (iii) allowing users to form group with which the users wish to share insurance policies, (iv) allowing insurance providers and users to determine current coverage amounts after each trip taken by the users, (v) providing insurance providers with the ability to charge more for high risk trips on a trip-to-trip basis, (vi) encouraging better driving behaviors for users through group insurance policies, (vii) providing an insurance policy where insurance providers can change corresponding premiums based upon driving behaviors/records of the users for the previous month(s), and/or (viii) providing insurance policies for users that do not drive or own a vehicle such that the users are covered for all modes of transportation. Further, the system described herein may address additional technical solutions.

### Exemplary Computer Network

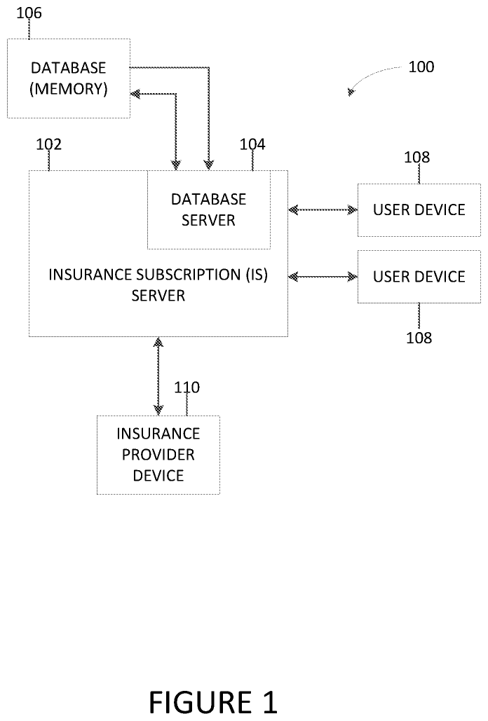

FIG. 1 depicts a simplified block diagram of an exemplary computer system 100 for providing subscription-based insurance policies. In the exemplary embodiment, system 100 may be used for providing subscription-based insurance policies including a predetermined coverage amount for one or more users (e.g., associated with user devices 108). In the exemplary embodiment, system 100 may include an insurance subscription (IS) server 102 and a database server 104. IS server 102 may be in communication with one or more databases 106 (or other memory devices), user devices 108, and/or insurance provider devices 110.

In the exemplary embodiment, user devices 108 may be computers that include a web browser or a software application, which enables user devices 108 to access remote computer devices, such as IS server 102, using the Internet or other network. More specifically, user devices 108 may be communicatively coupled to IS server 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. User devices 108 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

An insurance provider device 110 may be communicatively coupled with IS server 102. In some embodiments, insurance provider device 110 may be associated with, or is part of a computer network associated with an insurance provider, or in communication with the insurance provider's computer network (not shown). In other embodiments, insurance provider device 110 may be associated with a third party and is merely in communication with the insurance provider's computer network. That is, insurance provider device 110 may be associated with the insurance provider of the user. More specifically, insurance provider device 110 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Insurance provider device 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Database server 104 may be communicatively coupled to database 106 that stores data. In one embodiment, database 106 may include user data associated with users, telematics data of the users, insurance policy data (e.g., generated predesignated policies), coverage data (e.g., selected predesignated insurance policies of the users), adjustment data (e.g., relating to current coverage amounts), etc. In the exemplary embodiment, database 106 may be stored remotely from IS server 102. In some embodiments, database 106 may be decentralized. In the exemplary embodiment, a user may access database 106 and/or IS server 102 via user device 108.

IS server 102 may be in communication with a plurality of user devices 108 and insurance provider device 110 to generate predesignated policies including a predesignated coverage amount and a corresponding premium for a predesignated time period. In some embodiments, IS server 102 may be associated with an insurance provider or in communication with the insurance provider's computer network (not shown). In other embodiments, IS server 102 may be associated with a third party and may merely be in communication with the insurance provider device 110.

### Exemplary Process for Providing Reimbursement Controls

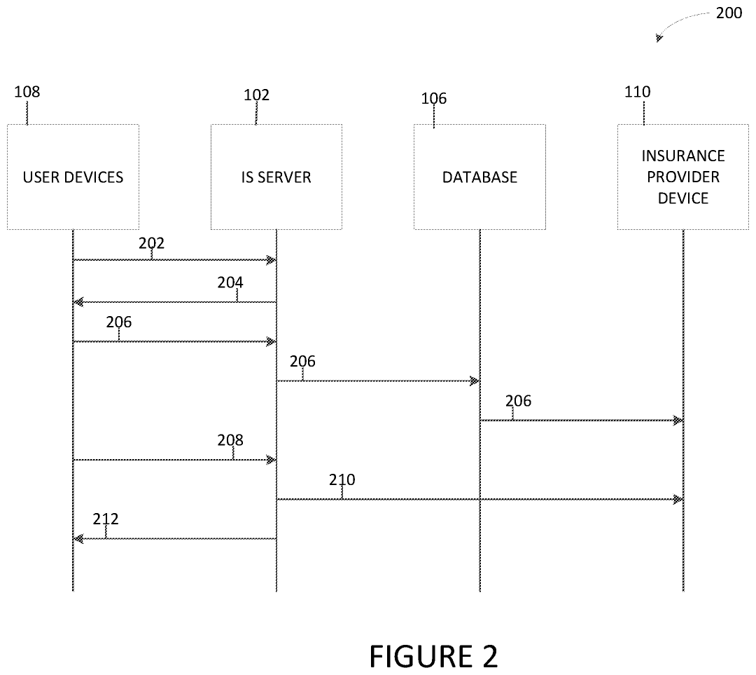

FIG. 2 illustrates a flow chart of an exemplary process 200 for providing group insurance plans to one or more users (e.g., associated with user devices 108). Process 200 may be carried out by computer system 100 (shown in FIG. 1).

In the exemplary embodiment, one or more users associated with user devices 108 may transmit registration data 202 and/or user data 202 to IS server 102. Registration data 202 may include a list of one or more users included in a group (e.g., for a group insurance plan) and user data 202 associated with each user included in the group. User data 202 may include at least one of demographics data, historical vehicle telematics data, and historical insurance claim data.

Based upon the received registration data 202 and/or user data 202, IS server 102 may generate a plurality of predesignated insurance/subscription policies 204 for the one or more users and transmit the plurality of predesignated insurance/subscription policies 204 to user devices 108. Each of the plurality of predesignated insurance/subscription policies 204 may include a predesignated coverage amount (e.g., a predesignated amount of miles, a predesignated amount of travel time, and/or a predesignated amount of trips) and a corresponding premium amount.

IS server 102 may prompt the one or more users to select (e.g., through a user interface and/or an application associated with IS server 102) one of the plurality of predesignated insurance/subscription policies 204, and a selected predesignated insurance/subscription policy 206 may be transmitted from user devices 108 to IS server 102. IS server 102 may then store selected insurance/subscription policy 206 in database 106 associated with IS server 102. Further, IS server 102 may transmit selected insurance/subscription policy 206 to insurance provider device 110 (e.g., associated with an insurance provider of the one or more users and/or associated with IS server 102). In some embodiments, user device 108 may transmit selected insurance/subscription policy 206 directly to database 106 and/or insurance provider device 110.

User devices 108 may transmit current vehicle telematics data 208 associated with the one or more users associated with user devices 108 to IS server 102. Current vehicle telematics data 208 may include any telematics data (e.g., any data associated with how a vehicle of the one or more users is operated). Current vehicle telematics data 208 may be generated by user devices 108 based upon telematics data from telematics sensors (e.g., GPS, gyroscope, accelerometer) of user devices and/or from telematics sensors of the vehicles of the one or more users.

IS server 102 may utilize current vehicle telematics data 208 to adjust a coverage amount and determine a current coverage amount 210. For example, the current coverage amount 210 may be equal to a previous current coverage amount minus a determined amount of miles, a determined amount of travel time, and/or determined trip (e.g., as determined by IS server 102 from current vehicle telematics data 208). IS server 102 may transmit current coverage amount 210 to insurance provider device 110. Further, IS server may store current coverage amount 210 in database 106.

IS server 102 may transmit notifications 212 to user devices 108. For example, notifications 212 may notify users when current coverage amount 210 is below a certain threshold, notify users each time current coverage amount 210 changes, and/or any other notification related to predesignated insurance/subscription policies 206 of the users.

### Exemplary User Device

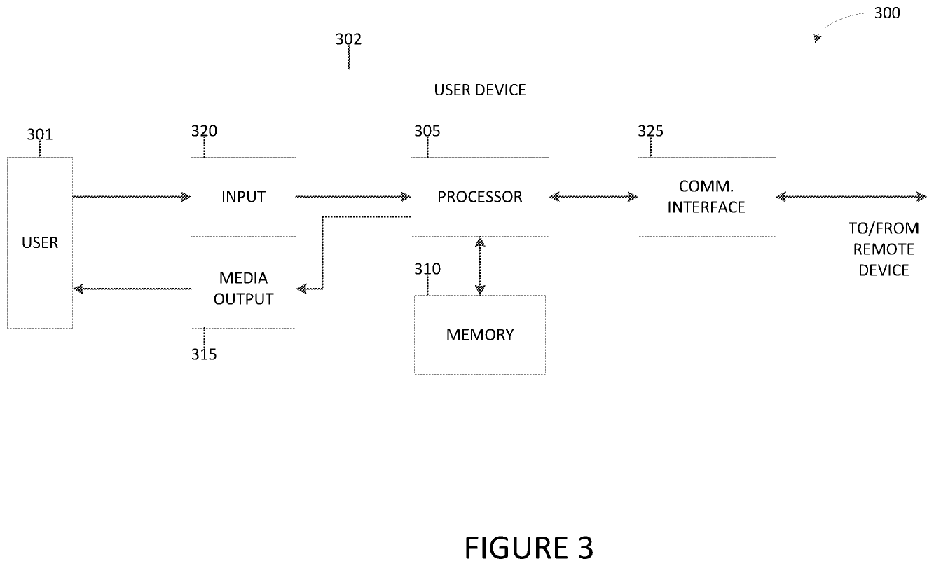

FIG. 3 depicts an exemplary configuration 300 of a user computer device 302 (e.g., user device 108, shown in FIG. 1), in accordance with one embodiment of the present disclosure. User computer device 302 may be operated by a user 301. User computer device 302 may include, but is not limited to, user device 108 and insurance provider device 110 (shown in FIG. 1). User computer device 302 may include a processor 305 for executing instructions. In some embodiments, executable instructions may be stored in a memory 310. Processor 305 may include one or more processing units (e.g., in a multi-core configuration). Memory 310 may be any device allowing information such as executable instructions and/or transaction data to be stored and retrieved. Memory 310 may include one or more computer readable media.

User computer device 302 may also include at least one media output component 315 for presenting information to user 301. Media output component 315 may be any component capable of conveying information to user 301. In some embodiments, media output component 315 may include an output adapter (not shown) such as a video adapter and/or an audio adapter. An output adapter may be operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 315 may be configured to present a graphical user interface (e.g., a web browser and/or a client application) to user 301. In some embodiments, user computer device 302 may include an input device 320 for receiving input from user 301. User 301 may use input device 320 to, without limitation, select a predesignated policy, submit user and/or registration data, add additional coverage, and/or change a coverage amount for subsequent predesignated policies.

Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325 communicatively coupled to a remote device, such as IS server 102 (shown in FIG. 1). Communication interface 325 may include, for example, a wired or wireless network adapter and/or a wireless data transceiver for use with a mobile telecommunications network.

Stored in memory 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from IS server 102 (shown in FIG. 1). A client application may allow user 301 to interact with, for example, IS server 102. For example, instructions may be stored by a cloud service, and the output of the execution of the instructions sent to the media output component 315.

### Exemplary Server Device

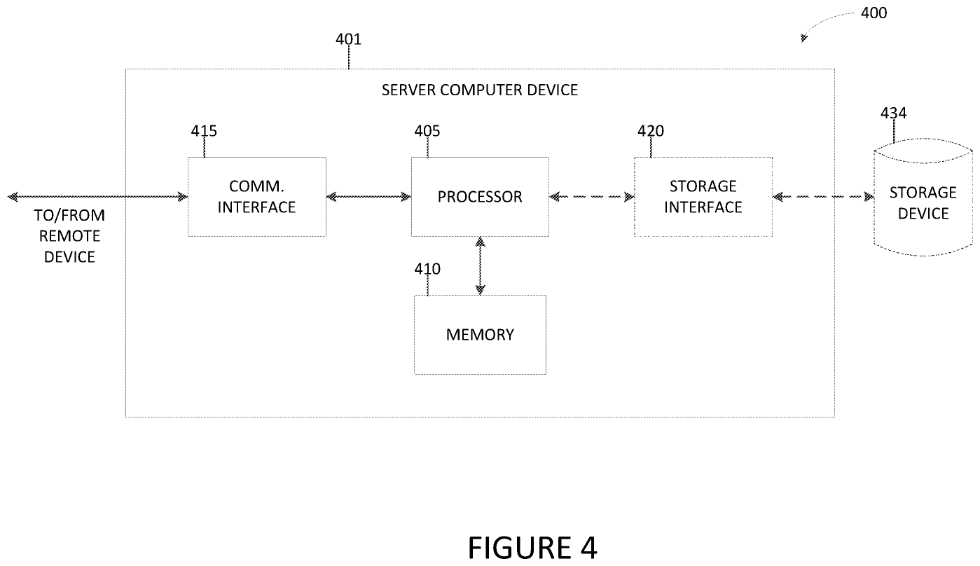

FIG. 4 depicts an exemplary configuration of a server system 400, in accordance with one embodiment of the present disclosure. A server computer device 401 may include, but is not limited to, IS server 102 and database server 104 (both shown in FIG. 1). Server computing device 401 may also include a processor 405 for executing instructions. Instructions may be stored in a memory area 410. Processor 405 may include one or more processing units (e.g., in a multi-core configuration).

Processor 405 may be operatively coupled to a communication interface 415 such that server computer device 401 is capable of communicating with a remote device such as another server computer device 401, IS server 102, user device 108, and insurance provider device 110 (shown in FIG. 1). For example, communication interface 415 may receive inputs, such as predesignated policy selections and/or submitted claims from user device 108 (shown in FIG. 1).

Processor 405 may also be operatively coupled to a storage device 420. Storage device 420 may be any computer-operated hardware suitable for storing and/or retrieving data. In some embodiments, storage device 420 may be integrated in server computer device 401. For example, server computer device 401 may include one or more hard disk drives as storage device 420.

In other embodiments, storage device 420 may be external to server computer device 401 and may be accessed by a plurality of server computer devices 401. For example, storage device 420 may include a storage area network (SAN), a network attached storage (NAS) system, and/or multiple storage units such as hard disks and/or solid state disks in a redundant array of inexpensive disks (RAID) configuration.

In some embodiments, processor 405 may be operatively coupled to storage device 420 via a storage interface 434. Storage interface 434 may be any component capable of providing processor 405 with access to storage device 420. Storage interface 434 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 420.

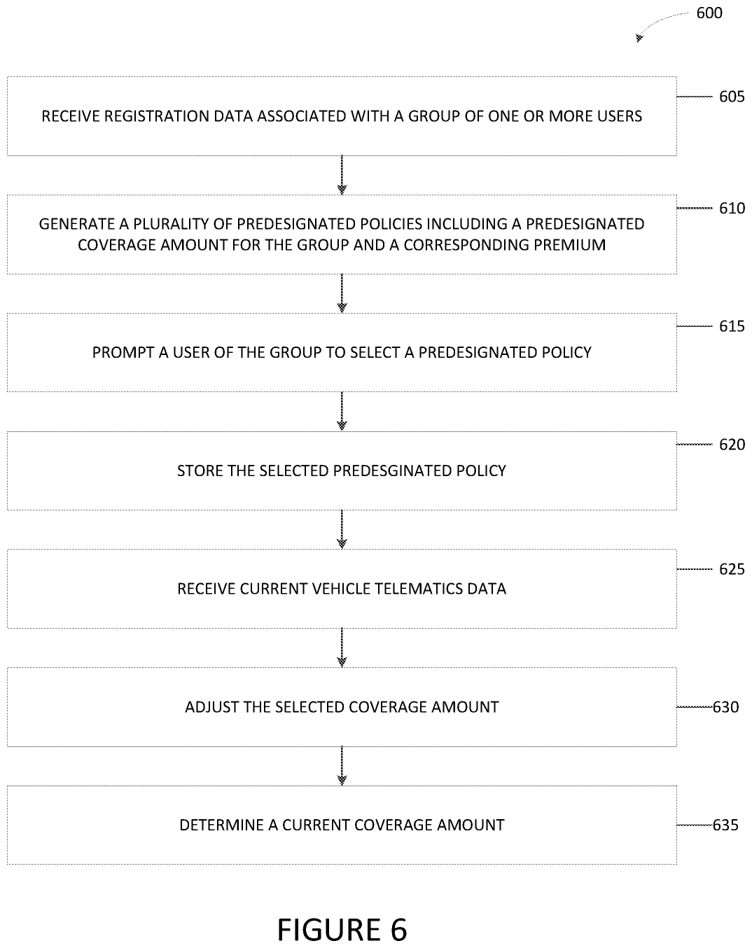

Processor 405 may execute computer-executable instructions for implementing aspects of the disclosure. In some embodiments, the processor 405 may be transformed into a special purpose microprocessor by executing computer-executable instructions or by otherwise being programmed, as described below in more detail with regard to FIG. 6.

### Exemplary Computer Device

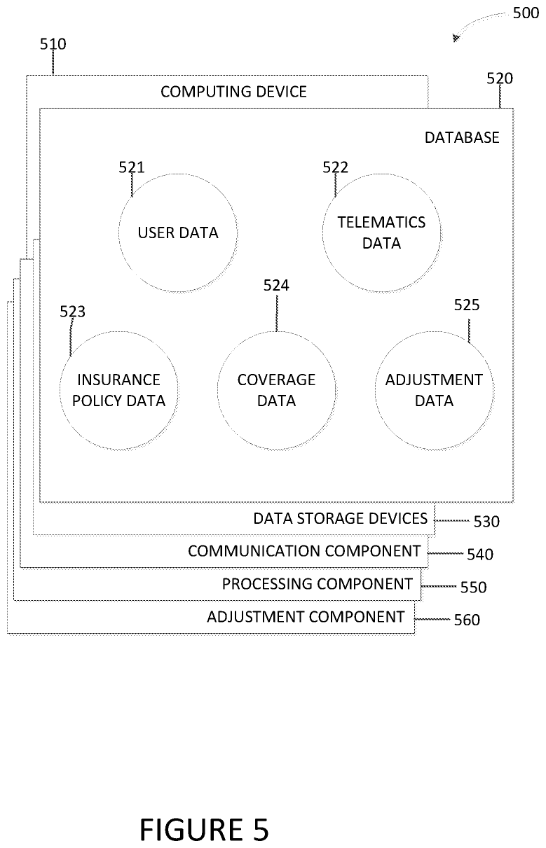

FIG. 5 depicts a diagram 500 of components of one or more exemplary computing devices that may be used in system 100 (shown in FIG. 1) and/or to carry out process 200 (shown in FIG. 2).

In some embodiments, computing device 510 may be similar to IS server 102 (shown in FIG. 1). Database 520 may be coupled with several separate components within computing device 510, which perform specific tasks. In this embodiment, database 520 may include user data 521 (e.g., historical driving data including historical telematics data and historical insurance claim data, user information including age, gender, and location, and group data), telematics data 522 (e.g., current telematics data of users, including acceleration, braking, cornering, speed, miles, and location information), insurance policy data 523 (e.g., generated predesignated policies based upon user data), coverage data 524 (e.g., selected predesignated policies for users and/or groups), and adjustment data 525 (e.g., current coverage amounts and risk factors). In some embodiments, database 520 is similar to database 106 (shown in FIG. 1).

Computing device 510 may include database 520, as well as a data storage device 530. Computing device 510 may also include a communication component 540 for transmitting and receiving data between IS server 102, user devices 108, and insurance provider device 110 (shown in FIG. 1). Computing device 510 may further include a processing component 550 that may, for example, process telematics data (e.g., received from user devices 108). An adjustment component 560 may assist with adjusting current coverage amounts according to current telematics data and/or risk factors.

### Exemplary Computer-Implemented Methods

FIG. 6 illustrates a flow chart of an exemplary computer-implemented process 600 for generating predesignated policies and associated predesignated coverage amounts and premiums for users. Process 600 may be implemented, at least in part, by a computing device/server, for example, IS server 102 (shown in FIG. 1).

Process 600 may include receiving 605 registration data associated with a group of one or more users. Registration data may include a list of one or more users included in the group of users and user data associated with each user included in the group. User data may include demographics data, historical vehicle telematics data, and historical insurance claim data. Process 600 may further include generating 610 a plurality of predesignated insurance policies, and each of the plurality of predesignated insurance policies may include a predesignated coverage amount and a corresponding premium amount. Further, the plurality of predesignated insurance policies may provide insurance coverage for a predesignated time period.

Process 600 may include prompting 615 a user (e.g. through a user device of the user and/or through an application associated with IS server 102) of the group to select a predesignated insurance policy. Once the user has selected the predesignated insurance policy, process 600 may include storing 620 the selected predesignated insurance policy (e.g., in a database associated with IS server 102). Process 600 may further include receiving 625 current vehicle telematics data of the one or more users included in the group and adjusting 630 the selected coverage amount based upon the current telematics data. Further, process 600 may include determining 635 a current coverage amount. Determining 635 the current coverage amount may include subtracting current telematics data from a previous coverage amount.

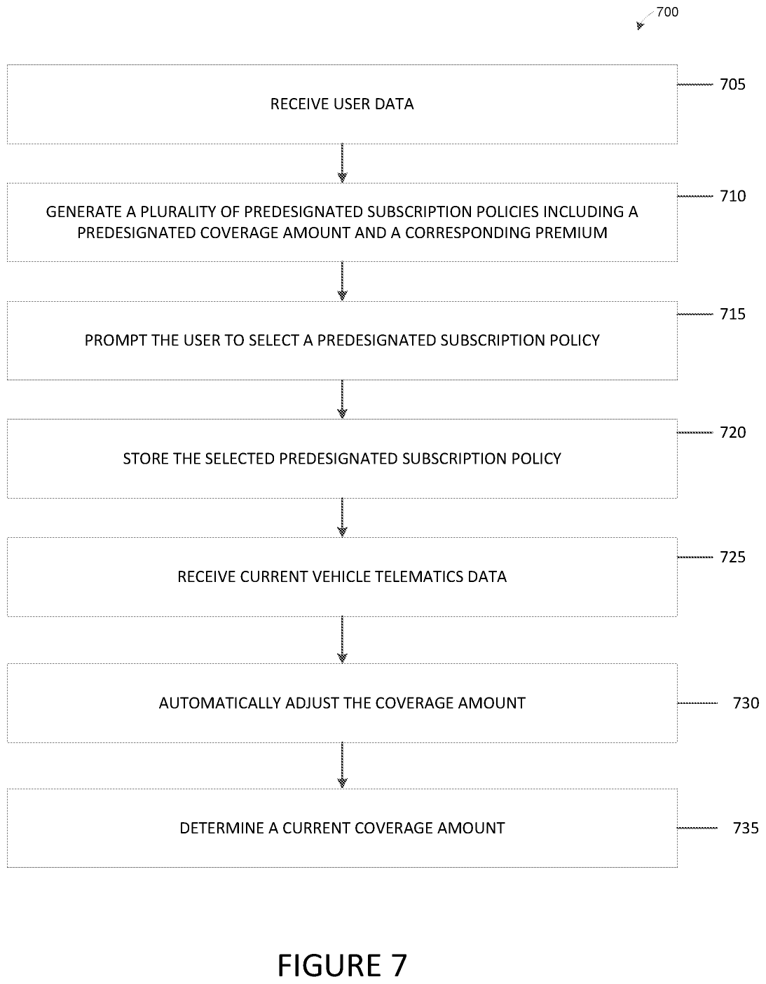

FIG. 7 illustrates a flow chart of an exemplary computer-implemented process 700 for a subscription insurance plan for users. Process 700 may be implemented, at least in part, by a computing device/server, for example, IS server 102 (shown in FIG. 1).

Process 700 may include receiving 705 user data. User data may include at least one of demographics data, historical vehicle telematics data, and historical insurance claim data. Process 700 may further include generating 710 a plurality of predesignated subscription policies including a predesignated coverage amount and a corresponding premium. Process 700 may include prompting 715 the user (e.g., through a user interface and/or through an application associated with IS server 102) to select a predesignated subscription policy, and storing 720 the selected predesignated subscription policy.

Process 700 may include receiving 725 current vehicle telematics data associated with the user. Based upon the current vehicle telematics data, process 700 may include automatically adjusting 730 the coverage amount associated with the selected predesignated subscription policy of the user. Further, process 700 may include determining 735 a current coverage amount.

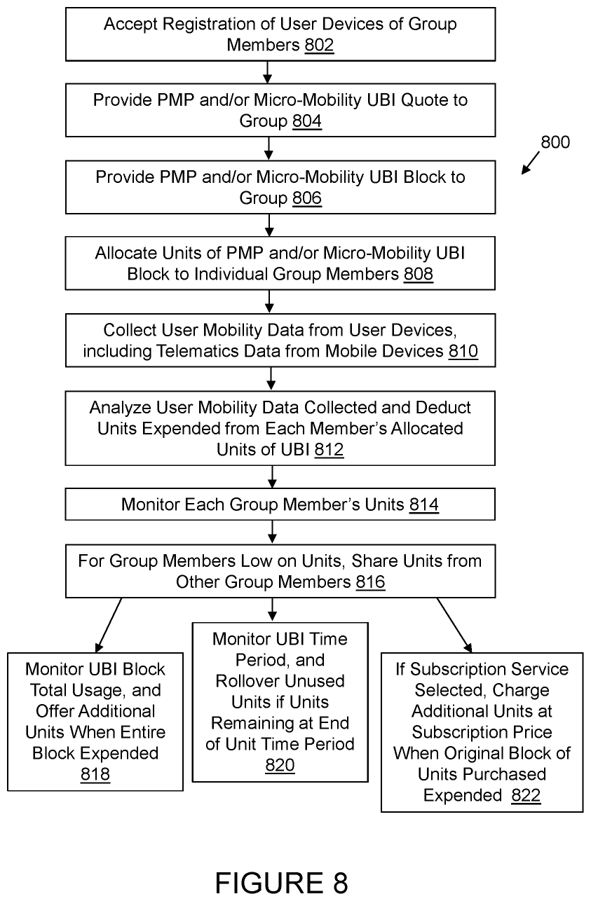

FIG. 8 illustrates a flow chart of an exemplary computer-implemented process 800 of allocating PMP (personal mobility plan) and micro-mobility usage-based insurance (UBI) blocks to group members. Process 800 may be implemented, at least in part, by a computing device/server, for example, IS server 102 (shown in FIG. 1).

Process 800 may include, via one or more local or remote processors, transceivers, sensors, and/or servers: accepting 802 registration of user devices of group members. For example, in order to form a group of insured, user computing devices (e.g., mobile devices, smart watches, wearables, and smart glasses) may be registered for wireless communication and data transfer with a remote server. The groups may include members of a family, household, apartment, peer group, affinity group, social group, or other group.

Process 800 may include, via one or more local or remote processors, transceivers, sensors, and/or servers: providing 804 a PMP and/or micro-mobility UBI quote to the group and/or group members. For example, PMP and/or micro-mobility insurance may be offered in various units, such as miles, time units, or rides. Micro-mobility insurance may cover short trips, such as the first mile and/or the last mile to a destination. For instance, the first mile and/or last mile to a destination may include users traveling by alternate forms of transportation, such as public transportation, ride shares, bicycles, or e-scooters.

Process 800 may include, via one or more local or remote processors, transceivers, sensors, and/or servers: providing 806 a PMP and/or micro-mobility UBI block of units to the group upon acceptance of the quote by the group.

Process 800 may include, via one or more local or remote processors, transceivers, sensors, and/or servers: allocating 808 units of the PMP and/or micro-mobility UBI block to specific individual group members. For example, the parents within a family group may be each initially allocated 100 units, while the children are each initially allocated 75 units.

Process 800 may include, via one or more local or remote processors, transceivers, sensors, and/or servers: collecting 810 user mobility data from user devices. For example, telematics data may be collected from group member mobile devices. The user mobility data may include group member location, speed, mode of transportation, origin, destination, and route information. The user mobility data may be generated by mobile device, wearable, smart glasses, or smart watch sensors, and received at a remote server via wireless communication or data transmission over one or more radio frequency links.

Process 800 may include, via one or more local or remote processors, transceivers, sensors, and/or servers: analyzing 812 the user mobility data collected to determine units (such as travel units designated by mile, time, ride, etc.) expended by each user or group member. Process 800 may include, via one or more local or remote processors, transceivers, sensors, and/or servers: further deducting the units expended from each group member's allocated units.

Process 800 may include, via one or more local or remote processors, transceivers, sensors, and/or servers: monitoring 814 each group member's remaining units, such as monitoring each member's remaining units in relation to zero or a predetermined low threshold limit, such as 5 or 10. Process 800 may include, via one or more local or remote processors, transceivers, sensors, and/or servers: for group members low on available or remaining units, sharing 816 units from other group members that have units remaining.

Process 800 may include, via one or more local or remote processors, transceivers, sensors, and/or servers: monitoring 818 UBI block usage, and offer additional units when the entire block available to the group is expended.

Process 800 may include, via one or more local or remote processors, transceivers, sensors, and/or servers: monitoring 820 the UBI time period, and rollover unused units if units remain at the end of the unit time period.

Process 800 may include, via one or more local or remote processors, transceivers, sensors, and/or servers: if subscription service is originally selected by the group when purchasing UBI, charge 822 any additional units at the subscription price when the original block of units purchased is expended. Further, process 800 may include additional, less, or alternate actions, including those discussed elsewhere herein.

### Exemplary Embodiments & Functionality

In an exemplary embodiment, a computer system for providing group insurance plans may be provided. The computer system may include at least one processor and/or associated transceiver in communication with at least one memory device, and the at least one processor and/or associated transceiver may be configured to: (i) receive registration data associated with a group of one or more users, wherein the group registration data includes (a) a list of the one or more users included in the group, and (b) user data associated with each user included in the group, wherein the user data includes at least one of demographics data, historical vehicle telematics data, and historical insurance claim data; (ii) generate, based upon the registration data, a plurality of predesignated insurance policies for the group, wherein each of the predesignated policies includes a predesignated coverage amount for the group and a corresponding premium amount over a predesignated time period; (iii) prompt at least one user of the group to select a predesignated policy; (iv) store, in the at least one memory device, the selected predesignated policy along with the group registration data; (v) receive current vehicle telematics data after each trip of each user of the group; (vi) adjust the selected coverage amount based upon the current vehicle telematics data; and/or (vii) determine a current coverage amount based upon the adjusted coverage amount. The computer system may include additional, less, or alternate functionality, including that discussed elsewhere herein.

For example, the predesignated coverage amount includes at least one of (i) a predesignated amount of miles, (ii) a predesignated amount of travel time, and (iii) a predesignated amount of trips, and a further enhancement may be that the at least one processor may be further configured to, after each trip: (i) determine, based upon the current vehicle telematics data for each trip, at least one of (a) an amount of miles driven on the trip, (b) an amount of travel time of the trip, and (c) that a trip was taken and/or (ii) subtract at least one of (a) the determined amount of miles driven on the trip, (b) the determined amount of travel time of the trip, and (c) a trip from a previous current coverage amount to determine a subsequent current coverage amount.

The at least one processor and/or associated transceiver may further be configured to: (i) determine when the current coverage amount falls below a threshold; (ii) transmit a notification to at least one user of the group, wherein the notification includes a message indicating that the current coverage amount is below the threshold; (iii) calculate an additional coverage amount for the group, wherein the additional coverage amount is calculated based upon the current coverage amount, and an amount of time left of the predesignated time period; (iv) prompt at least one user of the group to add the additional coverage amount to the current coverage amount; and/or (v) when the user adds the additional coverage amount, update the current coverage amount to include the additional coverage amount.

Additionally, the at least one processor and/or associated transceiver may further be configured to: (i) retrieve, after the predesignated time period has passed, claim data for each user of the group over the predesignated time period; (ii) determine whether any user of the group filed a claim in the predesignated time period; (iii) if it is determined that none of the users of the group filed a claim in the predesignated time period, provide a reward to the group, wherein the reward includes at least one of a discount on the premium for the selected predesignated policy and a credit toward the premium for the selected predesignated policy; and/or (iv) if it is determined that one or more users of the group filed a claim in the predesignated time period, generate a plurality of new predesignated policies for the group, wherein the new predesignated policies include a higher corresponding premium. Further, the group insurance policy may include a vehicle insurance policy for damage and injuries associated with a vehicle of the user, and the predesignated coverage amount may be an aggregate coverage amount shared by the group of users.

In the exemplary embodiment, a computer-implemented method for providing group insurance plans may be provided. The method may be implemented using a computer system including at least one processor and/or associated transceiver in communication with at least one memory device. The method may include, via the at least one processor and/or associate transceiver: (i) receiving registration data associated with a group of one or more users, wherein the group registration data includes (a) a list of the one or more users included in the group and (b) user data associated with each user included in the group, wherein the user data includes at least one of demographics data, historical vehicle telematics data, and historical insurance claim data; (ii) generating, based upon the registration data, a plurality of predesignated insurance policies for the group, wherein each of the predesignated policies includes a predesignated coverage amount for the group and a corresponding premium amount over a predesignated time period; (iii) prompting at least one user of the group to select a predesignated policy; (iv) storing, in the at least one memory device, the selected predesignated policy along with the group registration data, (v) receiving current vehicle telematics data after each trip of each user of the group; (vi) adjusting the selected coverage amount based upon the current vehicle telematics data; and/or (vii) determining a current coverage amount based upon the adjusted coverage amount. The method may include additional, less, or alternate actions, including those discussed elsewhere herein.

In the exemplary embodiment, at least one non-transitory computer-readable media having computer-executable instructions thereon may be provided. When executed by at least one processor and/or associated transceiver of a computer system in communication with at least one memory device, the instructions may cause the at least one processor and/or associated transceiver to: (i) receive registration data associated with a group of one or more users, wherein the group registration data includes (a) a list of the one or more users included in the group and (b) user data associated with each user included in the group, wherein the user data includes at least one of demographics data, historical vehicle telematics data, and historical insurance claim data; (ii) generate, based upon the registration data, a plurality of predesignated insurance policies for the group, wherein each of the predesignated policies includes a predesignated coverage amount for the group and a corresponding premium amount over a predesignated time period; (iii) prompt at least one user of the group to select a predesignated policy; (iv) store, in the at least one memory device, the selected predesignated policy along with the group registration data; (v) receive current vehicle telematics data after each trip of each user of the group; (vi) adjust the selected coverage amount based upon the current vehicle telematics data; and/or (vii) determine a current coverage amount based upon the adjusted coverage amount. The instructions may direct additional, less, or alternate functionality, including that discussed elsewhere herein.

Further, in the exemplary embodiment, a computer system for providing a subscription insurance plan may be provided. The computer system may include at least one processor and/or associated transceiver in communication with at least one memory device, and the at least one processor and/or associated transceiver may be configured to: (i) receive user data associated with a user, wherein the user data includes at least one of demographics data, historical vehicle telematics data, and historical insurance claim data; (ii) generate, based upon the user data, a plurality of predesignated subscription policies, wherein each of the predesignated subscription policies includes a predesignated coverage amount, for damage and injuries associated with a vehicle of the user, and a corresponding premium amount for a predesignated time period; (iii) generate, based upon the user data, a plurality of predesignated subscription policies, wherein each of the predesignated subscription policies includes a predesignated coverage amount, for damage and injuries associated with a vehicle of the user, and a corresponding premium amount for a predesignated time period; (iv) store, in the at least one memory device, the selected predesignated subscription policy along with the corresponding user data; (v) receive current vehicle telematics data after each trip of the user using the insured vehicle, wherein the user was a driver of the insured vehicle; (vi) automatically adjust the coverage amount based upon the current vehicle telematics data; and/or (vii) determine a current coverage amount based upon the adjusted coverage amount. The computer system may include additional, less, or alternate functionality, including that discussed elsewhere herein.

For example, the predesignated coverage amount may include at least one of (a) a predesignated amount of miles, (b) a predesignated amount of travel time, and (c) a predesignated amount of trips, and an enhancement may be that after each trip the at least one processor and/or associated transceiver is further configured to: (i) determine, based upon the current vehicle telematics data for each trip, at least one of (a) an amount of miles driven on the trip, (b) an amount of travel time of the trip, and (c) that a trip was taken; and/or (ii) subtract at least one of (a) the determined amount of miles driven on the trip, (b) the determined amount of travel time of the trip, and (c) a trip from a previous current coverage amount to determine a subsequent current coverage amount.

The at least one processor and/or associated transceiver may further be configured to: (i) after each trip, determine a risk factor associated with the trip; (ii) generate a risk multiplier for the trip, wherein a risk multiplier of less than one corresponds to the trip having a low risk factor, and wherein a risk multiplier greater than one corresponds to the trip having a high risk factor; (iii) determine, based upon the current vehicle telematics data for each trip, at least one of (a) an amount of miles driven on the trip, (b) an amount of travel time of the trip, and (c) that a trip was taken; (iv) adjust at least one of (a) the determined amount of miles driven on the trip, (b) the determined amount of travel time of the trip, and (c) the determined trip taken based upon the risk multiplier; and/or (v) subtract the at least one of (a) the adjusted amount of miles driven on the trip, (b) the adjusted amount of travel time of the trip, and (c) the adjusted trip from a previous current coverage amount to determine a subsequent current coverage amount.

The at least one processor and/or associated transceiver may further be configured to: (i) after the predesignated time period has passed, analyze the current coverage amount; (ii) determine a coverage amount remaining from the predesignated coverage amount based upon the current coverage amount; (iii) recommend, based upon the determined coverage amount remaining, a new predesignated subscription policy for a subsequent time period; (iv) prompt the user to select one of subscribing to the new predesignated subscription policy and maintaining the selected predesignated subscription policy; (v) adjust a subsequent coverage amount based upon the determined coverage amount remaining, wherein the determined coverage amount remaining is added to a subsequent coverage amount for a subsequent time period of the selected predesignated subscription policy of the user; (vi) determine when the current coverage amount falls below a threshold; and/or (v) transmit a notification to the user, wherein the notification includes a message indicating that the current coverage amount is below the threshold.

In the exemplary embodiment, a computer-implemented method for providing a subscription insurance plan may be provided. The method may be implemented using a computer system including at least one processor and/or associated transceiver in communication with at least one memory device. The method may include, via the at least one processor and/or associated transceiver: (i) receiving user data associated with a user, wherein the user data includes at least one of demographics data, historical vehicle telematics data, and historical insurance claim data; (ii) generating, based upon the user data, a plurality of predesignated subscription policies, wherein each of the predesignated subscription policies includes a predesignated coverage amount, for damage and injuries associated with a vehicle of the user, and a corresponding premium amount for a predesignated time period; (iii) prompting the user to select a predesignated subscription policy from the plurality of predesignated subscription policies; (iv) storing, in the at least one memory device, the selected predesignated subscription policy along with the corresponding user data; (v) receiving current vehicle telematics data after each trip of the user using the insured vehicle, wherein the user was a driver of the insured vehicle; (vi) automatically adjusting the coverage amount based upon the current vehicle telematics data; and/or (vii) determining a current coverage amount based upon the adjusted coverage amount. The method may include additional, less, or alternate actions, including those discussed elsewhere herein.

In the exemplary embodiment, at least one non-transitory computer-readable media having computer-executable instructions thereon may be provided. When executed by at least one processor and/or associated transceiver of a computer system in communication with at least one memory device, the instructions may cause the at least one processor and/or associated transceiver to: (i) receive user data associated with a user, wherein the user data includes at least one of demographics data, historical vehicle telematics data, and historical insurance claim data; (ii) generate, based upon the user data, a plurality of predesignated subscription policies, wherein each of the predesignated subscription policies includes a predesignated coverage amount, for damage and injuries associated with a vehicle of the user, and a corresponding premium amount for a predesignated time period; (iii) generate, based upon the user data, a plurality of predesignated subscription policies, wherein each of the predesignated subscription policies includes a predesignated coverage amount, for damage and injuries associated with a vehicle of the user, and a corresponding premium amount for a predesignated time period; (iv) store, in the at least one memory device, the selected predesignated subscription policy along with the corresponding user data; (v) receive current vehicle telematics data after each trip of the user using the insured vehicle, wherein the user was a driver of the insured vehicle; (vi) automatically adjust the coverage amount based upon the current vehicle telematics data; and/or (vii) determine a current coverage amount based upon the adjusted coverage amount. The instructions may direct additional, less, or alternate functionality, including that discussed elsewhere herein.

In another embodiment, a computer system for providing group insurance plans, the computer system including at least one processor in communication with at least one memory device may be provided. The at least one processor may be configured to: (i) receive registration data associated with a group of one or more users, wherein the group registration data includes (a) a list of the one or more users included in the group and (b) user data associated with each user included in the group, wherein the user data includes at least one of demographics data, historical vehicle telematics data, and historical insurance claim data, (ii) generate, based upon the registration data, a plurality of predesignated insurance policies for the group, wherein each of the predesignated policies includes a predesignated coverage amount for the group and a corresponding premium amount over a predesignated time period, and wherein the group insurance plans include at least one of a personal mobility policy plan and a usage-based insurance plan, (iii) prompt at least one user of the group to select a predesignated policy, (iv) store, in the at least one memory device, the selected predesignated policy along with the group registration data, (v) receive, from user computing devices associated with each user, user mobility data after each trip of each user of the group, (vi) adjust the selected coverage amount based upon the user mobility data, and/or (vii) determine a current coverage amount based upon the adjusted coverage amount. The computer system may include additional, less, or alternate functionality, including that discussed elsewhere herein.

For example, the predesignated coverage amount includes at least one of (i) a predesignated amount of miles, (ii) a predesignated amount of travel time, and (iii) a predesignated amount of trips, and a further enhancement may be that the at least one processor may be further configured to, after each trip: (i) determine, based upon the current vehicle telematics data for each trip, at least one of (a) an amount of miles driven on the trip, (b) an amount of travel time of the trip, and (c) that a trip was taken and/or (ii) subtract at least one of (a) the determined amount of miles driven on the trip, (b) the determined amount of travel time of the trip, and (c) a trip from a previous current coverage amount to determine a subsequent current coverage amount.

The at least one processor and/or associated transceiver may further be configured to: (i) determine when the current coverage amount falls below a threshold; (ii) transmit a notification to at least one user of the group, wherein the notification includes a message indicating that the current coverage amount is below the threshold; (iii) calculate an additional coverage amount for the group, wherein the additional coverage amount is calculated based upon the current coverage amount, and an amount of time left of the predesignated time period; (iv) prompt at least one user of the group to add the additional coverage amount to the current coverage amount; and/or (v) when the user adds the additional coverage amount, update the current coverage amount to include the additional coverage amount.

Additionally, the at least one processor and/or associated transceiver may further be configured to: (i) retrieve, after the predesignated time period has passed, claim data for each user of the group over the predesignated time period; (ii) determine whether any user of the group filed a claim in the predesignated time period; (iii) if it is determined that none of the users of the group filed a claim in the predesignated time period, provide a reward to the group, wherein the reward includes at least one of a discount on the premium for the selected predesignated policy and a credit toward the premium for the selected predesignated policy; and/or (iv) if it is determined that one or more users of the group filed a claim in the predesignated time period, generate a plurality of new predesignated policies for the group, wherein the new predesignated policies include a higher corresponding premium. Further, the group insurance policy may include a vehicle insurance policy for damage and injuries associated with a vehicle of the user, and the predesignated coverage amount may be an aggregate coverage amount shared by the group of users.

Further, the at least one processor and/or associated transceiver may further be configured to: (i) allocate a coverage amount to each user of the group, (ii) identify when the coverage amount allocated for one or more users of the group falls below a predetermined threshold, and/or (iii) in response to the coverage amount of the one or more users falling below the predetermined threshold, transfer a coverage amount from at least one other user to the identified one or more users, wherein the at least one other user has a coverage amount above the predetermined threshold. The personal mobility policy plans may provide insurance protection for customers who do not own a vehicle or do not drive, and the personal mobility policy plans may provide insurance protection for users who travel via alternative forms of transportation, including walking, biking, using public transportation, and using ride-sharing services. The UBI plans may include UBI micro-mobility insurance coverage, and the UBI plans may be sold by time, mileage, and rides. The UBI plans may provide coverage for modes of transportation with speeds less than 20 miles per hour, that only carry 1 or 2 people, and are associated with trips of short distances.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, personal possession, claim, policy, and/or reimbursement data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, home owner and/or home, renter, geolocation information, image data, and/or other data.

Based upon these analyses, the processing element may learn how to identify characteristics and patterns that may then be applied to analyzing user data, policy data, item data, and/or other data. For example, the processing element may learn, with the user's permission or affirmative consent, to predict items, categories of items, and values associated with the categories of items associated with the user.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A computer system for leveraging vehicle telematics data, the computer system comprising at least one processor in communication with at least one memory device and telematics sensors associated with a vehicle, the at least one processor configured to:
receive user data associated with at least two users of the vehicle;
receive historical telematics data associated with the vehicle, wherein the historical telematics data was generated by the telematics sensors, and wherein the telematics sensors are included in at least one of (i) one or more user devices associated with the at least two users or (ii) the vehicle;
determine, utilizing machine learning tools and the user data, driving patterns unique to each user from the historical telematics data;
identify each user based upon the driving patterns;
analyze, utilizing the machine learning tools, the user data, the driving patterns, and the historical telematics data;
generate, based upon the analysis, historical vehicle operation metrics for each user, the historical vehicle operation metrics for each user including driving characteristics when each user was driving the vehicle;
receive, from the telematics sensors, current vehicle telematics data after each trip of the vehicle;
determine a driver for each trip of the vehicle by comparing the current vehicle telematics data for each trip to the historical vehicle operation metrics for each user;
for each trip where one of the at least two users is the determined driver of the vehicle, generate a subset of the current vehicle telematics data associated with the corresponding user as the driver;
determine, using the subset of the current vehicle telematics data, actual usage metrics for each user; and
train the machine learning tools using the actual usage metrics for each user.

2. The computer system of claim 1, wherein the at least one processor is further configured to:
after each trip, determine a risk factor associated with the trip; and
generate a risk multiplier for the trip, wherein when the risk multiplier is less than one, the risk multiplier corresponds to the trip having a low risk factor, and wherein when the risk multiplier risk multiplier is greater than one, the risk multiplier corresponds to the trip having a high risk factor.

3. The computer system of claim 1, wherein the at least one processor is further configured to:
generate, in real-time based upon the user data and the historical vehicle operation metrics, a plurality of predesignated subscription policies to insure each user while driving the vehicle, each of the predesignated subscription policies including a predesignated coverage amount for a predesignated time period; and
cause to be displayed, on each user device of the one or more user devices, the plurality of predesignated subscription policies generated for the corresponding user of the at least two users.

4. The computer system of claim 3, wherein the at least one processor is further configured to:
receive, from each user device, (i) a selection of one of the plurality of predesignated subscription policies for the corresponding user, (ii) payment information, and (iii) data required for an insurance provider associated with the selected predesignated subscription policy to finalize the selected predesignated subscription policy.

5. The computer system of claim 3, wherein the at least one processor is further configured to:
automatically determine a remaining coverage amount for the predesignated time period of a selected predesignated subscription policy by comparing the actual usage metrics to the predesignated coverage amount;
display, through a corresponding user device of the one or more user device, the remaining coverage amount to the corresponding user; and
add the remaining coverage amount to a subsequent time period of the selected predesignated subscription policy.

6. The computer system of claim 1, wherein the at least one processor is further configured to:
determine, based upon the current vehicle telematics data for each trip, at least one of (i) an amount of miles driven on the trip, (ii) an amount of travel time of the trip, or (iii) that the trip was take.

7. The computer system of claim 6, wherein the at least one processor is further configured to:
adjust at least one of (i) the determined amount of miles driven on the trip, (ii) the determined amount of travel time of the trip, or (iii) the determined trip taken based upon a risk multiplier for the trip; and
determine a subsequent remaining coverage amount by subtracting, from a previous remaining coverage amount of a selected predesignated subscription policy, the at least one of (i) the adjusted amount of miles driven on the trip, (ii) the adjusted amount of travel time of the trip, or (iii) the adjusted trip.

8. A computer-implemented method for leveraging vehicle telematics data, the method implemented using a computer system including at least one processor in communication with at least one memory device and telematics sensors associated with a vehicle, the method comprising:
receiving user data associated with at least two users of the vehicle;
receiving historical telematics data associated with the vehicle, wherein the historical telematics data was generated by the telematics sensors, and wherein the telematics sensors are included in at least one of (i) one or more user devices associated with the at least two users or (ii) the vehicle;
determining, utilizing machine learning tools and the user data, driving patterns unique to each user from the historical telematics data;
identifying each user based upon the driving patterns;
analyzing, utilizing the machine learning tools, the user data, the driving patterns, and the historical telematics data;
generating, based upon the analysis, historical vehicle operation metrics for each user, the historical vehicle operation metrics for each user including driving characteristics when each user was driving the vehicle;
receiving, from the telematics sensors, current vehicle telematics data after each trip of the vehicle;
determining a driver for each trip of the vehicle by comparing the current vehicle telematics data for each trip to the historical vehicle operation metrics for each user;
for each trip where one of the at least two users is the determined driver of the vehicle, generating a subset of the current vehicle telematics data associated with the corresponding user as the driver;
determining, using the subset of the current vehicle telematics data, actual usage metrics for each user; and
training the machine learning tools using the actual usage metrics for each user.

9. The computer-implemented method of claim 8 further comprising:
after each trip, determining a risk factor associated with the trip; and
generating a risk multiplier for the trip, wherein when the risk multiplier is less than one, the risk multiplier corresponds to the trip having a low risk factor, and wherein when the risk multiplier risk multiplier is greater than one, the risk multiplier corresponds to the trip having a high risk factor.

10. The computer-implemented method of claim 8 further comprising:
generating, in real-time based upon the user data and the historical vehicle operation metrics, a plurality of predesignated subscription policies to insure each user while driving the vehicle, each of the predesignated subscription policies including a predesignated coverage amount for a predesignated time period; and
causing to be displayed, on each user device of the one or more user devices, the plurality of predesignated subscription policies generated for the corresponding user of the at least two users.

11. The computer-implemented method of claim 10 further comprising:
receiving, from each user device, (i) a selection of one of the plurality of predesignated subscription policies for the corresponding user, (ii) payment information, and (iii) data required for an insurance provider associated with the selected predesignated subscription policy to finalize the selected predesignated subscription policy.

12. The computer-implemented method of claim 10 further comprising:
automatically determining a remaining coverage amount for the predesignated time period of a selected predesignated subscription policy by comparing the actual usage metrics to the predesignated coverage amount;
displaying, through a corresponding user device of the one or more user device, the remaining coverage amount to the corresponding user; and
adding the remaining coverage amount to a subsequent time period of the selected predesignated subscription policy.

13. The computer-implemented method of claim 8 further comprising:
determining, based upon the current vehicle telematics data for each trip, at least one of (i) an amount of miles driven on the trip, (ii) an amount of travel time of the trip, or (iii) that the trip was take.

14. The computer-implemented method of claim 13 further comprising:
adjusting at least one of (i) the determined amount of miles driven on the trip, (ii) the determined amount of travel time of the trip, or (iii) the determined trip taken based upon a risk multiplier for the trip; and
determining a subsequent remaining coverage amount by subtracting, from a previous remaining coverage amount of a selected predesignated subscription policy, the at least one of (i) the adjusted amount of miles driven on the trip, (ii) the adjusted amount of travel time of the trip, or (iii) the adjusted trip.

15. At least one non-transitory computer-readable storage medium having computer-executable instructions embodied thereon, wherein when executed by at least one processor in communication with at least one memory device and telematics sensors associated with a vehicle, the computer-executable instructions cause the at least one processor to:
receive user data associated with at least two users of the vehicle;
receive historical telematics data associated with the vehicle, wherein the historical telematics data was generated by the telematics sensors, and wherein the telematics sensors are included in at least one of (i) one or more user devices associated with the at least two users or (ii) the vehicle;
determine, utilizing machine learning tools and the user data, driving patterns unique to each user from the historical telematics data;
identify each user based upon the driving patterns;
analyze, utilizing the machine learning tools, the user data, the driving patterns, and the historical telematics data;
generate, based upon the analysis, historical vehicle operation metrics for each user, the historical vehicle operation metrics for each user including driving characteristics when each user was driving the vehicle;
receive, from the telematics sensors, current vehicle telematics data after each trip of the vehicle;
determine a driver for each trip of the vehicle by comparing the current vehicle telematics data for each trip to the historical vehicle operation metrics for each user;
for each trip where one of the at least two users is the determined driver of the vehicle, generate a subset of the current vehicle telematics data associated with the corresponding user as the driver;
determine, using the subset of the current vehicle telematics data, actual usage metrics for each user; and
train the machine learning tools using the actual usage metrics for each user.

16. The at least one non-transitory computer-readable medium of claim 15, wherein the computer-executable instructions further cause the at least one processor to:
after each trip, determine a risk factor associated with the trip; and
generate a risk multiplier for the trip, wherein when the risk multiplier is less than one, the risk multiplier corresponds to the trip having a low risk factor, and wherein when the risk multiplier risk multiplier is greater than one, the risk multiplier corresponds to the trip having a high risk factor.

17. The at least one non-transitory computer-readable medium of claim 15, wherein the computer-executable instructions further cause the at least one processor to:
generate, in real-time based upon the user data and the historical vehicle operation metrics, a plurality of predesignated subscription policies to insure each user while driving the vehicle, each of the predesignated subscription policies including a predesignated coverage amount for a predesignated time period; and
cause to be displayed, on each user device of the one or more user devices, the plurality of predesignated subscription policies generated for the corresponding user of the at least two users.

18. The at least one non-transitory computer-readable medium of claim 17, wherein the computer-executable instructions further cause the at least one processor to:
automatically determine a remaining coverage amount for the predesignated time period of a selected predesignated subscription policy by comparing the actual usage metrics to the predesignated coverage amount;
display, through a corresponding user device of the one or more user device, the remaining coverage amount to the corresponding user; and
add the remaining coverage amount to a subsequent time period of the selected predesignated subscription policy.

19. The at least one non-transitory computer-readable medium of claim 15, wherein the computer-executable instructions further cause the at least one processor to:
determine, based upon the current vehicle telematics data for each trip, at least one of (i) an amount of miles driven on the trip, (ii) an amount of travel time of the trip, or (iii) that the trip was take.

20. The at least one non-transitory computer-readable medium of claim 19, wherein the computer-executable instructions further cause the at least one processor to:
adjust at least one of (i) the determined amount of miles driven on the trip, (ii) the determined amount of travel time of the trip, or (iii) the determined trip taken based upon a risk multiplier for the trip; and
determine a subsequent remaining coverage amount by subtracting, from a previous remaining coverage amount of a selected predesignated subscription policy, the at least one of (i) the adjusted amount of miles driven on the trip, (ii) the adjusted amount of travel time of the trip, or (iii) the adjusted trip.
